(19) United States
(12) Patent Application Publication
(10) Pub. No.: US 2025/0196687 A1
(43) Pub. Date: Jun. 19, 2025

(54) SOLAR POWER TRANSFER SYSTEM WITH ELECTRIC FIELD POWER GENERATOR

(71) Applicant: AWL-ELECTRICITY INC, MONTREAL (CA)

(72) Inventors: Francis BEAUCHAMP-VERDON, SAINT-LAMBERT (CA); Cedric HAMEL-BRUNEAU, MONTREAL (CA); Victor AVEZARD, MONTREAL (CA)

(73) Assignee: AWL-ELECTRICITY INC, MONTREAL (CA)

(21) Appl. No.: 18/973,253

(22) Filed: Dec. 9, 2024

Related U.S. Application Data
(60) Provisional application No. 63/610,436, filed on Dec. 15, 2023.

(51) Int. Cl. B60L 53/51; B60L 53/10; B60L 53/68; H02J 3/38

(52) U.S. Cl. CPC B60L 53/51; B60L 53/11; B60L 53/68; H02J 3/381; H02J 2300/24

(57) ABSTRACT

The present solar power transfer system comprises a solar cell array, an Electric Field Power Generator (EFPG), and a controller. The solar cell array is adapted for capturing solar energy and transforming the solar energy into solar-sourced Direct Current (DC) electricity. The EFPG is adapted for transmitting electric energy wirelessly to an Electric Field Potential Converter (EFPC). The controller is adapted for receiving the solar-sourced DC electricity and providing the solar-sourced DC electricity to the EFPG for wireless transfer as wireless electric energy. Optionally, the controller comprises a connection to grid power for receiving Alternate Current (AC) electricity, an AC/DC converter for converting the AC electricity into grid-sourced DC electricity, and a power management modulator for combining the grid-sourced DC electricity to the solar-sourced DC electricity, and providing the combined grid-sourced DC electricity and solar-sourced DC electricity to the EFPG for wireless transfer as wireless electric energy.

### TECHNICAL FIELD

The present disclosure relates to the field of solar power transfer. More specifically, the present disclosure presents a solar power transfer system using electric field generation.

### BACKGROUND

Wireless power transfer of electric energy is based on the capability of transferring electric energy without establishing a conductive contact therebetween. Wireless power transfer avoids the use of an electrical connector (e.g. an electrical power outlet or a Universal Serial Bus (USB) cable, power cables, etc.).

Various techniques for implementing wireless power transfer have been known for a long time (although implementation of these techniques on an industrial and commercial scale are more recent). One of these techniques is based on electric field coupling systems, which use electrically conductive plates for generating an electric field. More recent techniques further rely on generating a resonant electric field.

Systems using resonant electric fields operating at a high frequency are referred to as high frequency resonant capacitive coupling systems. Such systems have advantages in terms of security (e.g. no energy is displaced in the air which avoids health hazards, no eddy current is generated which avoids material damage caused by heat generation, operations at a safe frequency according to government standards). Such systems also have advantages in terms of operational robustness (e.g. resilience to misalignment of receiver and transmitter).

The generation of the electric field is performed by an Electric Field Power Generator (EFPG). The conversion of the electric field potential into electricity is performed by an Electric Field Potential Converter (EFPC). The EFPC can be integrated into multiple devices having various form factors and electrical power needs (e.g. a battery, a car, a wheelchair, an electrical and/or electronic consumer device, etc.).

The present disclosure aims at providing a solar power transfer system using electric field generation.

The present solar power transfer system may be used for directly charging the battery of devices, for example devices having a greater power capacity or greater power demand. For example, the present solar power transfer system may be used for contactless charging of the battery of an electrical vehicle.

### SUMMARY

According to a first aspect, the present disclosure provides a solar power transfer system comprising a solar cell array, an Electric Field Power Generator (EFPG) and a controller. The solar cell array is adapted for capturing solar power and transforming the solar power into solar-sourced Direct Current (DC) electricity. The EFPG is adapted for transmitting electric energy wirelessly to an Electric Field Potential Converter (EFPC). The controller receives the solar-sourced DC electricity and provides the solar-sourced DC electricity to the EFPG for wireless transfer as wireless electric energy.

In a particular aspect, the controller further comprises a connection to grid power for receiving Alternate Current (AC) electricity. The controller also comprises an AC/DC converter for converting the AC electricity into grid-sourced DC electricity. The controller also comprises a power management modulator for combining the grid-sourced DC electricity to the solar-sourced DC electricity, and providing the combined grid-sourced DC electricity and solar-sourced DC electricity to the EFPG for wireless transfer as wireless electric energy.

In another particular aspect, the power management modulator further adjusts the grid-sourced DC electricity to limit the combined grid-sourced DC electricity and solar-sourced DC electricity below a predetermined threshold.

In still another particular aspect, the solar power transfer system further comprises a data collection module adapted to sense at least one of the following: the solar-sourced DC electricity received by the controller, the grid-sourced AC electricity received by the controller, the grid-sourced DC electricity generated by the AC/DC converter, the combined solar-sourced DC electricity and grid-sourced DC electricity provided to the EFPG, date and time, presence or non-presence of a vehicle in proximity of the EFPG, and speed of recharge of the vehicle by the solar power transfer system.

In yet another particular aspect, the solar power transfer system also comprises a communication module adapted to transmit data collected by the data collection module to at least one of an electronic device and a cloud-based server.

In another particular aspect, the EFPG comprises a generating cell adapted for converting electric power received by the EFPG into an electric field potential. The electric energy being wirelessly transmitted to the EFPC by the generating cell through one of: capacitive coupling and resonant capacitive coupling.

In still another particular aspect, the solar power transfer system further comprises the EFPC for receiving the wireless electric energy transmitted by the EFPG and providing electric power to one of an electric device, a battery and a battery pack.

In yet another aspect, the EFPC is adapted for electrical connection to a battery or a battery pack adapted to be wirelessly recharged through the EFPG.

In another particular aspect, the battery or battery pack is located in a vehicle, and the EFPC is positioned proximate to the EFPG.

In still another particular aspect, the EFPC is adapted for electrical connection to an electric device for electrically powering the electric device.

In accordance with a second aspect, the present disclosure provides a wireless electricity transmission system. The wireless electricity transmission system comprises an Electric Field Power Generator (EFPG), a controller and an Electric Field Potential Converter (EFPC). The EFPP is adapted for transmitting electric energy wirelessly to the EFPC. The controller is adapted for receiving solar-sourced DC electricity from a solar cell array, and provides the solar-sourced DC electricity to the EFPG for wireless transfer as wireless electric energy. The EFPC is adapted to be electrically connected to an electric device. The EFPC is adapted for receiving the wireless electric energy and powering therewith the electric device.

In a particular aspect, the controller further comprises a connection to grid power for receiving Alternate Current (AC) electricity. The controller also comprises an AC/DC converter for converting the AC electricity into grid-sourced DC electricity. The controller further comprises a power management modulator for combining the grid-sourced DC electricity to the solar-sourced DC electricity, and providing the combined grid-sourced DC electricity and solar-sourced DC electricity to the EFPG for wireless transfer as wireless electric energy.

In another particular aspect, the power management modulator further adjusts the grid-sourced DC electricity to limit the combined grid-sourced DC electricity and solar-sourced DC electricity below a predetermined threshold.

In still another particular aspect, the wireless electricity transmission system further comprises a data collection module adapted to sense at least one of the following: the solar-sourced DC electricity received by the controller, the grid-sourced AC electricity received by the controller, the grid-sourced DC electricity generated by the AC/DC converter, the combined solar-sourced DC electricity and grid-sourced DC electricity provided to the EFPG, date and time, presence or non-presence of a vehicle in proximity of the EFPG, and speed of recharge of the vehicle by the wireless electricity transmission system.

In yet another particular aspect, the wireless electricity transmission system also comprises a communication module adapted to transmit data collected by the data collection module to at least one of an electronic device and a cloud-based server.

In another particular aspect, the EFPG comprises a generating cell adapted for converting electric power received by the EFPG into an electric field potential, the EFPC comprises a converting cell adapted for coupling with the electric field generated by the generating cell of the EFPG and converting the absorbed electric field potential into electric energy for powering therewith the electric device, the coupling with the electric field being one of: capacitive coupling and resonant capacitive coupling.

In still another particular aspect, the EFPC is adapted for electrical connection to a battery of the electric device.

### BRIEF DESCRIPTION OF THE DRAWINGS

Embodiments of the disclosure will be described by way of example only with reference to the accompanying drawings, in which:

FIG. 1 is a schematic representation of an exemplary wireless power transfer system.

FIG. 2 is another schematic representation of the exemplary wireless power transfer system used for powering a load;

FIG. 3 is an exemplary schematic representation of a solar power transfer system installed on a roof or installed as a roof or roofing material;

FIG. 4 is another exemplary schematic representation of the solar power solar power transfer system installed on a wall; and

FIG. 5 is an exemplary functional diagram of a controller of the solar power transfer system of FIGS. 4 and 5.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to the limitations in terms of wireless power transfer and more particularly to a solar power transfer system adapted for wireless power transfer, by means of an electric field power generator.

Throughout the present specification, the following expressions are used as follows.

Electrical conductive plate: an area of conductive material, the conductive material may be continuous or a structure of conductive material interspersed with non-conductive material. Throughout the present specification, the word plate is meant to refer to any shape and not solely to a polygon.

Conductive material: material with a high conductivity rating, i.e. low electrical resistivity. Examples of conductive materials include copper, iron, gold, aluminum, silver and alloys made thereof.

Electric device: any type of electrically energized apparatus, tool or device, including electronic equipment (wireless phones, tablets, computers, headphones, earbuds, keyboards, screens, gamepads, cameras, LED lights, etc.), tools (power tools, kitchen small appliances, small appliances, fans, etc.), medical devices, specialized devices and apparatuses, etc.

Electric Field Potential Converter (EFPC): electric mechanism by which a conductive material absorbs electric field potential and converts the absorbed electric field potential into electric energy. The EFPC may rely on capacitive coupling or resonant capacitive coupling alone or in combination with inductive coupling and/or inductive resonant coupling.

Capacitive coupling between an Electric Field Power Generator (EFPG) and an Electric Field Potential Converter (EFPC) allows transfer of electric energy therebetween. Although the dielectric properties of space between the EFPG and the EFPC cannot be controlled, the electric properties of the assemblies generating the electric field or absorbing the electrical potential and converting the absorbed electrical potential must be carefully selected and the assemblies manufactured to optimize the efficient transfer of electric energy therebetween. In addition to electric energy, the integration of the EFPC to daily used electric devices could greatly improve their operation and convenience.

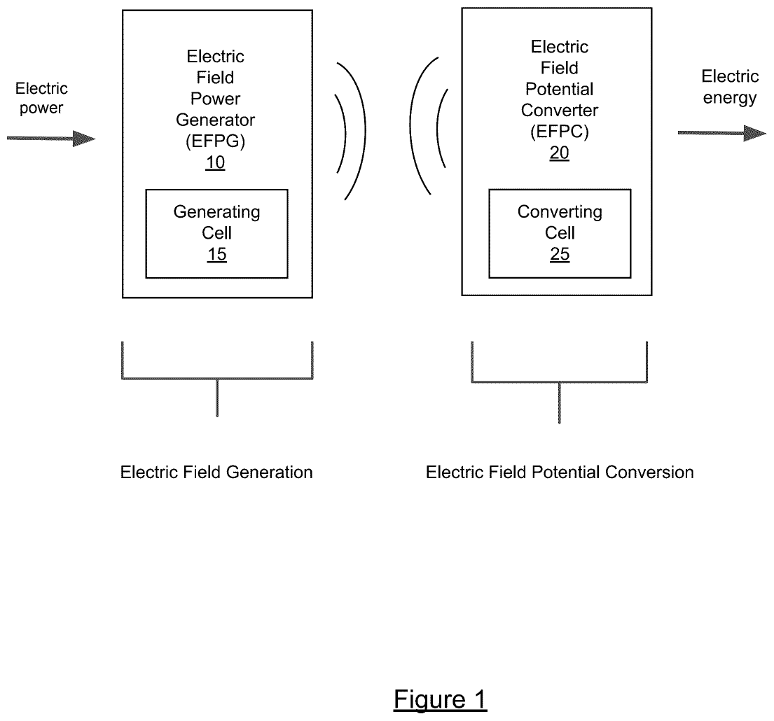

Reference is made to FIG. 1, which is a schematic representation illustrating the concepts of electric field generation and electric field power conversion. An Electric Field Power Generator (EPFG) 10 is connected to a source of electric power, and generates therefrom an electric field. The electric field propagates in the air between the EPFG 10 and an Electric Field Potential Converter (EFPC) 20. The EFPC 20 absorbs the electric field potential and converts the absorbed electric field potential into electrical energy. The electrical energy may be used to recharge a battery, to electrify an electric device, a combination of both, etc.

The EPFG 10 comprises a generating cell 15 and the EFPC 20 comprises a converting cell 25. The generating cell 15 and the converting cell 25 respectively comprise electrical conductive plates (not represented in FIG. 1 for simplification purposes). In an exemplary configuration, each one of the generating cell 15 and the converting cell 25 comprise a group of electrical conductive plates, either adjacent, stacked or concentrically positioned, in which at least two of the plates are electrically connected. Furthermore, the shape and dimensions of the EPFG 10, generating cell 15, EFPC 20 and converting cell 25 may vary.

In operation, the EFPG 10 generates an electric field and the EFPC 20 couples with the electric field generated by the EFPG 10. More specifically, the electrical conductive plates of the generating cell 15 generate the electric field and the electrical conductive plates of the converting cell 25 couple with the electric field generated by the EFPG 10. The generating cell 15 further comprises electric components and/or materials (for converting the electric power received by the EFPG 10 into the electric field potential). The converting cell 25 further comprises electric components and/or materials (for converting the absorbed electric field potential into electric energy).

Various configurations of the generating cell 15 and the converting cell 25 suitable for capacitive electrical coupling, and more particularly resonant capacitive electrical coupling, may be used. Furthermore, the generating cell 15 and the converting cell 25 may use the same or different configurations for their respective (groups of) electrical conductive plates.

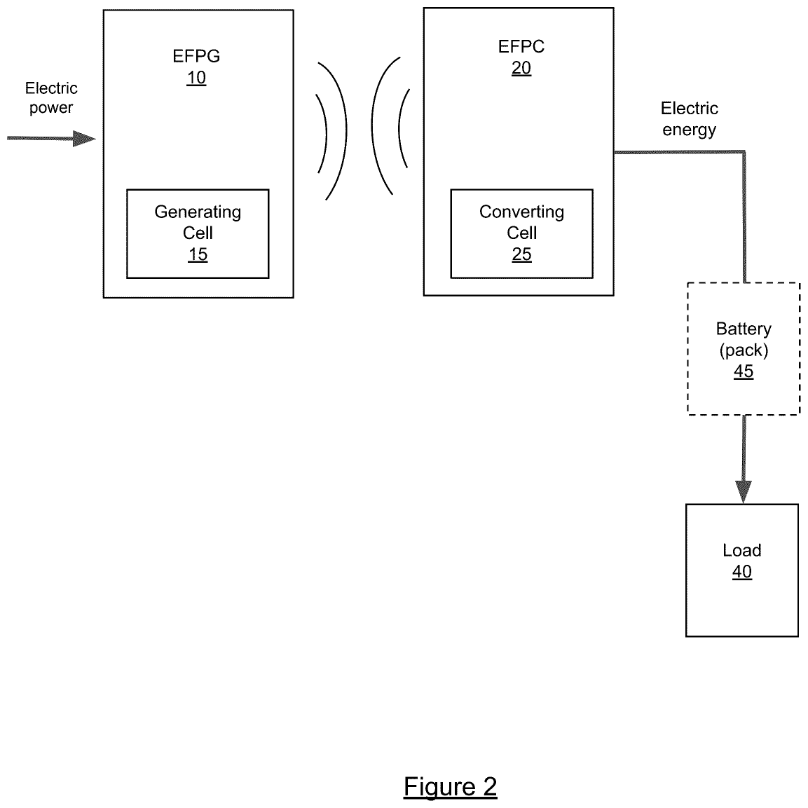

Reference is now made to FIG. 2, which represents the EFPC 20 powering a load 40. In a first configuration, the EFPC 20 directly powers the load 40. An AC/DC converter (not shown in FIG. 2) may further be included in the EFPC 20. The load 40 may include one or several loads 40 (e.g. electrical motor, electronic circuit, one or several batteries, etc.).

In another configuration, the EFPC 20 powers a battery or battery pack 45, or a battery charger adapted for charging the battery or battery pack (not represented in FIG. 2). The load 40 is not directly powered by the EFPC 20 but through the battery or battery pack 45. The EFPC 20 may or may not be integrated to the battery, battery pack or battery charger.

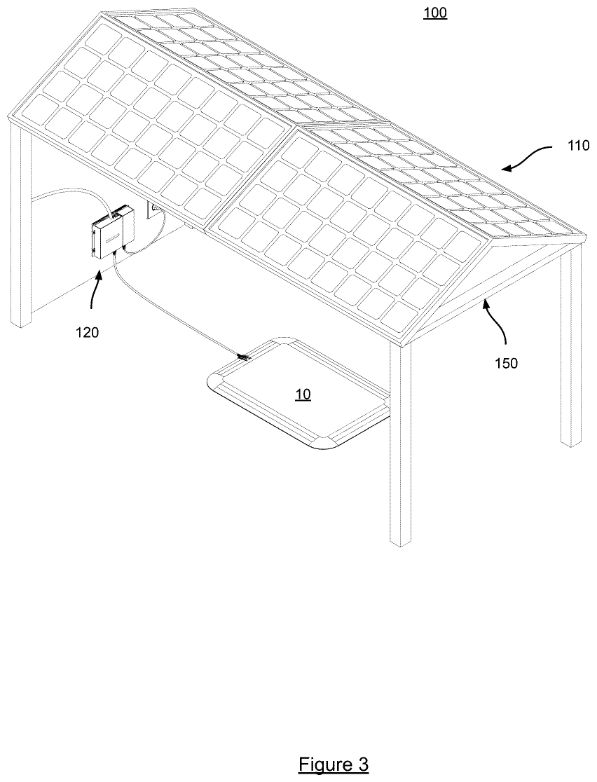

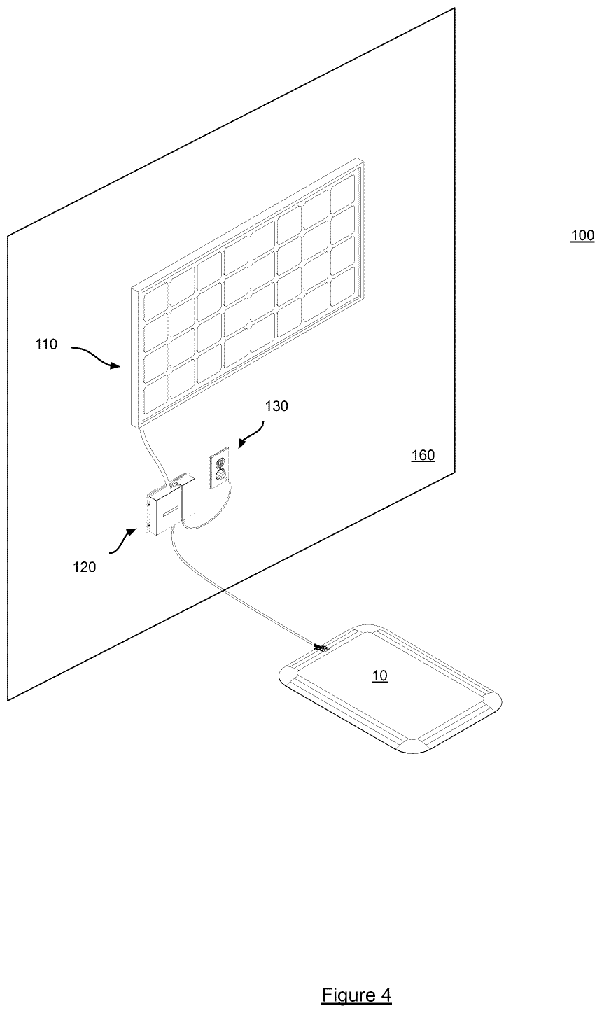

Reference is now made concurrently to FIGS. 1, 3 and 4, where FIGS. 3 and 4 illustrate example schematic representations of a solar power transfer (SWPT) system 100. The SWPT system 100 comprises a solar cell array 110 for capturing solar energy and transforming the solar energy into solar-sourced Direct Current (DC) electricity. FIG. 3 illustrates the solar cell array 110 installed on a roof 150 and FIG. 4 illustrates the solar cell array 110 installed on a wall 160. The solar cell array 110 may include any number, configuration or type of solar cells known in the art.

The solar system 100 further comprises the EFPG 10. The EFPG 10 has been described previously. The corresponding EFPC 20 of FIG. 1 is not represented in FIGS. 3 and 4 for simplification purposes. FIGS. 3 and 4 represent the EFPG 10 laying on the ground. However, the location and positioning of the EFPG 10 may vary.

The SWPT system 100 further comprises a controller 120 for receiving the solar-sourced DC electricity from the solar cell array 110 and providing the solar-sourced DC electricity to the EFPG 10, to perform the previously described wireless power transfer.

The controller 120 comprises a connection to grid power for receiving Alternate Current (AC) electricity. For instance, FIG. 4 represents the controller 120 being connected to an electric outlet 130 providing access to AC electricity from the electrical grid.

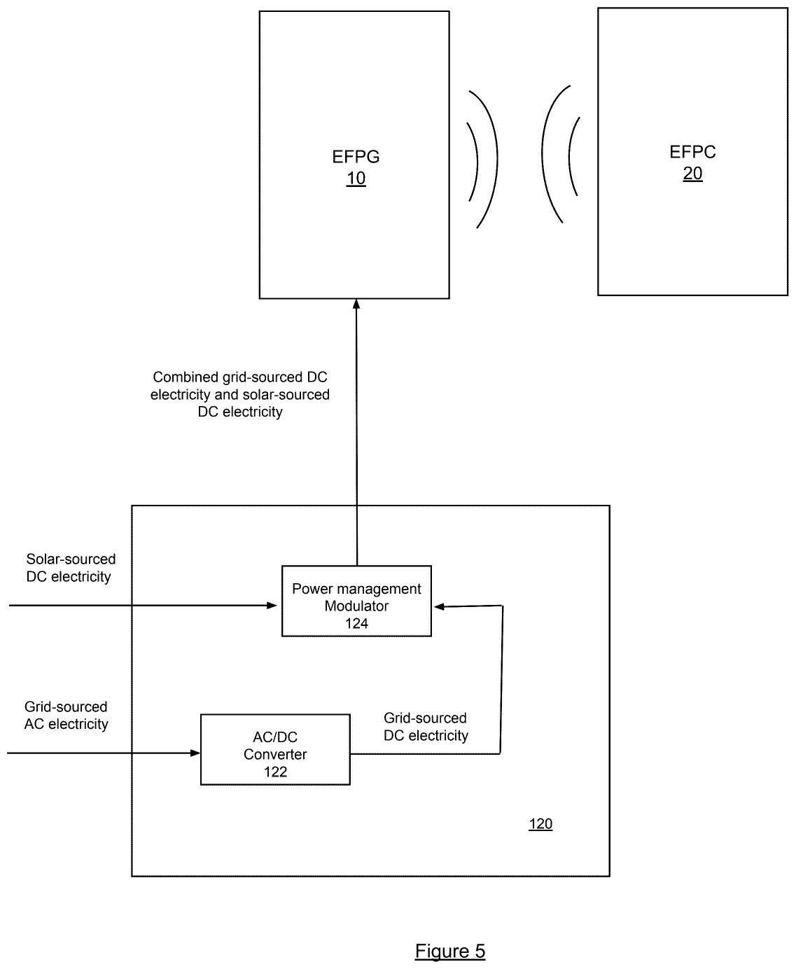

Components of the controller 120 adapted for receiving the solar-sourced DC electricity from the solar cell array 110 and the AC electricity from the electrical grid are not illustrated in FIG. 5 and further described in detail, since they are well known in the art and out of the scope of the present disclosure.

The controller 120 further comprises an AC/DC converter 122 for converting the AC electricity into grid-sourced DC electricity. The controller 120 further comprises a power management modulator 124 for combining the grid-sourced DC electricity to the solar-sourced DC electricity. The combined grid-sourced DC electricity and solar-sourced DC electricity is provided to the EFPG 10, for wireless power transmission to the EFPC 20. The power management modulator 124 is adapted for further adjusting the grid-sourced DC electricity to limit the combined grid-sourced DC electricity and solar-sourced DC electricity below a predetermined threshold.

When the solar cell array 110 produces sufficient DC energy, the power management modulator 124 of the controller 120 live feeds the EFPG 10 and stops using the grid power.

Combining the solar cell array 110 with the controller 120 and the EFPG 10 is advantageous from an energy standpoint, as it efficiently and flexibly relies on solar energy, in addition to providing a greener solution from a hardware standpoint to recharging electric devices, vehicles and batteries.

Following is a use case where the solar system 100 is used for charging a vehicle (not represented in the Figures for simplification purposes). The vehicle is an electrical vehicle or a standard vehicle, with a battery or battery pack. In this case, the EFPC 20 is located inside the vehicle, to recharge the battery or battery pack. The EFPG 10 has a shape and dimensions (e.g. similar to a carpet adapted to lay on the ground, as illustrated in FIGS. 3 and 4) adapted to have the EFPC 20 in the vehicle positioned proximate to the EFPG 10, to perform the wireless power transfer.

Positioning the solar cell array 110 above the vehicle further casts shade over the vehicle, thereby reducing ambient temperature of the vehicle, as well as temperature of the battery or battery pack in the vehicle, to further improve durability and life expectancy.

Although not illustrated, the SWPT system 100 may further be provided with a communication module and a data collection module. The data collection module is adapted to sense at least one of the following: the solar-sourced DC electricity received by the controller 120, the grid-sourced AC electricity received by the controller and/or the grid-sourced DC electricity generated by the AC/DC converter 122, the combined solar-sourced DC electricity and grid-sourced DC electricity provided to the EFPG 10 (to be wirelessly transmitted), the date and time, the presence or non-presence of the vehicle in proximity of the EFPG 10, a speed of recharge of the vehicle by the SWPT system 100, as well as any other information related to the operation and functioning of the SWPT system 100 as a whole, or components thereof. Data collected by the data collection module may be transmitted by means of the communication module to an electronic device and/or a cloud-based server for analysis and reporting.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A solar power transfer system comprising:
a solar cell array for capturing solar energy and transforming the solar energy into solar-sourced Direct Current (DC) electricity;
an Electric Field Power Generator (EFPG), the EFPG transmitting electric energy wirelessly to an Electric Field Potential Converter (EFPC); and
a controller for receiving the solar-sourced DC electricity and providing the solar-sourced DC electricity to the EFPG for wireless transfer as wireless electric energy.

2. The solar power transfer system of claim 1, wherein the controller further comprises:
a connection to grid power for receiving Alternate Current (AC) electricity;
an AC/DC converter for converting the AC electricity into grid-sourced DC electricity; and
a power management modulator for combining the grid-sourced DC electricity to the solar-sourced DC electricity, and providing the combined grid-sourced DC electricity and solar-sourced DC electricity to the EFPG for wireless transfer as wireless electric energy.

3. The solar power transfer system of claim 2, wherein the power management modulator further adjusts the grid-sourced DC electricity to limit the combined grid-sourced DC electricity and solar-sourced DC electricity below a predetermined threshold.

4. The solar power transfer system of claim 2, further comprising a data collection module adapted to sense at least one of the following: the solar-sourced DC electricity received by the controller, the grid-sourced AC electricity received by the controller, the grid-sourced DC electricity generated by the AC/DC converter, the combined solar-sourced DC electricity and grid-sourced DC electricity provided to the EFPG, date and time, presence or non-presence of a vehicle in proximity of the EFPG, and speed of recharge of the vehicle by the solar power transfer system.

5. The solar power transfer system of claim 4, further comprising a communication module adapted to transmit data collected by the data collection module to at least one of an electronic device and a cloud-based server.

6. The solar power transfer system of claim 1, wherein the EFPG comprises a generating cell adapted for converting electric power received by the EFPG into an electric field potential, the electric energy being wirelessly transmitted to the EFPC by the generating cell through one of: capacitive coupling and resonant capacitive coupling.

7. The solar power transfer system of claim 1, further comprising the EFPC for receiving the wireless electric energy transmitted by the EFPG and providing electric power to one of an electric device, a battery and a battery pack.

8. The solar power transfer system of claim 7, wherein the EFPC is adapted for electrical connection to a battery or a battery pack adapted to be wirelessly recharged through the EFPG.

9. The solar power transfer system of claim 8, wherein the battery or battery pack is located in a vehicle, and the EFPC is positioned proximate to the EFPG.

10. The solar power transfer system of claim 7, wherein the EFPC is adapted for electrical connection to an electric device for electrically powering the electric device.

11. A wireless electricity transmission system comprising:
an Electric Field Power Generator (EFPG) for transmitting electric energy wirelessly to an Electric Field Potential Converter (EFPC);
a controller for receiving solar-sourced DC electricity from a solar cell array, and for providing the solar-sourced DC electricity to the EFPG for wireless transfer as wireless electric energy; and
the EFPC adapted to be electrically connected to an electric device, the EFPC receiving the wireless electric energy and powering therewith the electric device.

12. The wireless electricity transmission system of claim 11, wherein the controller further comprises:
a connection to grid power for receiving Alternate Current (AC) electricity;
an AC/DC converter for converting the AC electricity into grid-sourced DC electricity; and
a power management modulator for combining the grid-sourced DC electricity to the solar-sourced DC electricity, and providing the combined grid-sourced DC electricity and solar-sourced DC electricity to the EFPG for wireless transfer as wireless electric energy.

13. The wireless electricity transmission system of claim 12, wherein the power management modulator further adjusts the grid-sourced DC electricity to limit the combined grid-sourced DC electricity and solar-sourced DC electricity below a predetermined threshold.

14. The wireless electricity transmission system of claim 12, further comprising a data collection module adapted to sense at least one of the following: the solar-sourced DC electricity received by the controller, the grid-sourced AC electricity received by the controller, the grid-sourced DC electricity generated by the AC/DC converter, the combined solar-sourced DC electricity and grid-sourced DC electricity provided to the EFPG, date and time, presence or non-presence of a vehicle in proximity of the EFPG, and speed of recharge of the vehicle by the wireless electricity transmission system.

15. The wireless electricity transmission system of claim 14, further comprising a communication module adapted to transmit data collected by the data collection module to at least one of an electronic device and a cloud-based server.

16. The wireless electricity transmission system of claim 11, wherein the EFPG comprises a generating cell adapted for converting electric power received by the EFPG into an electric field potential, the EFPC comprises a converting cell adapted for coupling with the electric field generated by the generating cell of the EFPG and converting the absorbed electric field potential into electric energy for powering therewith the electric device, the coupling with the electric field being one of: capacitive coupling and resonant capacitive coupling.

17. The wireless electricity transmission system of claim 11, wherein the EFPC is adapted for electrical connection to a battery of the electric device.
